(19) United States
(12) Patent Application Publication
(10) Pub. No.: US 2011/0291614 A1
(43) Pub. Date: Dec. 1, 2011

(54) WIRELESS CHARGER FOR USE IN AUTOMOBILE

(76) Inventor: Ming-Hsiang YEH, Taipei City (TW)

(21) Appl. No.: 13/118,735

(22) Filed: May 31, 2011

(30) Foreign Application Priority Data
May 31, 2010 (TW) 099210283

(51) Int. Cl. H02J 7/04

(52) U.S. Cl. 320/108

(57) ABSTRACT

A wireless charge is provided for use in an automobile and includes a main body having a transmitter circuit and a power member. The main body has a surface to which a clip section is mounted so that coupling with an electronic device can be realized through the clip section. The power member is electrically connectable with a cigarette lighter of the automobile and the main body, whereby the power member transmits the electrical power supplied from the cigarette lighter to the transmitter circuit to allow the transmitter circuit to convert the electrical power into an AC signal, which is transmitted in a wireless manner to a receiver circuit of the electronic device to electrically charge a rechargeable battery of the receiver circuit. As such, a user may perform electrical charging of the electronic device during the travel of the automobile.

### FIELD OF THE INVENTION

The present invention relates to an electrical charging device, and in particular to a wireless charger for use in an automobile to electrically charge an electronic device during the travel of the automobile.

### BACKGROUND OF THE INVENTION

With the continuous progress of technology and science, the demand for electronic devices by general consumers is increasingly upgraded, especially for consumer electronic products. Electronic devices, which were bulky in size, such as optic disk players, household telephones, and desk-top computers, are being changed to compact and portable electronic products of high performance, such as multimedia player (for example MPEG Audio Layer-3, MP3), mobile phones, and notebook computers, all leading to a more efficient life for human beings.

Most of such portable electronic products, including the multimedia players and mobile phones, are powered by rechargeable batteries or cells, such as nickel hydride battery and lithium battery. The rechargeable battery is re-chargeable through a charging device or charger, which is composed of a charging seat and an electrical connector. The charging seat forms a charging chamber in which the rechargeable battery is positioned, while the electrical connector is set in connection with a power socket, such as a wall outlet to supply a required voltage or current to charge the rechargeable battery. The charging device is only useful in an environment where a power socket is available, with the electrical power being supplied through connection lines to the rechargeable battery. This limits the range where the charging device or the rechargeable battery is useful.

In view of such problems, the present invention aims to provide a wireless charger for use in automobile, which overcomes the limitation of range of use and is easy to use.

### SUMMARY OF THE INVENTION

An objective of the present invention is to provide a wireless charger for use in automobile, which allows an electronic device to be re-charged during the travel of the automobile, and thereby alleviates the limitation of range of use caused by the conventional drawbacks of being only useful in an environment where a power socket is available and requiring wired connection of the conventional charging device.

To achieve the above objective, the present invention provides a wireless charger for use in an automobile comprising a cigarette lighter and being coupleable with an electronic device comprising a receiver circuit. The wireless charger comprises: a main body, which comprises a transmitter circuit and at least one clip section, the electronic device being positionable on the main body and engageable with the clip section to couple the electronic device with the main body; and a power member, which has an end connected to the main body and an opposite end that is electrically connectable with the cigarette lighter of the automobile, whereby the power member transmits electrical power supplied from the cigarette lighter to the transmitter circuit to allow the transmitter circuit to convert the electrical power into an alternate-current signal, which is transmitted by the transmitter circuit to the receiver circuit in a wireless manner. As such, the problem of limited range of use caused by being only useful in an area where a power socket is available and requiring wired connection with the charger can be overcome, and ease of use is realized.

### BRIEF DESCRIPTION OF THE DRAWINGS

The present invention will be apparent to those skilled in the art by reading the following description of preferred embodiments thereof with reference to the drawings, in which:

FIGS. 1A and 1B are perspective views of a wireless charger for use in automobile according to the first embodiment of the present invention;

FIGS. 1C and 1D are perspective views illustrating use of the wireless charger according to the first embodiment of the present invention;

FIGS. 1E-1H are circuit diagrams of the wireless charger according to the first embodiment of the present invention;

FIG. 2A is a perspective view showing a wireless charger for use in automobile according to a second embodiment of the present invention;

FIG. 2B is a perspective view illustrating use of the wireless charger according to the second embodiment of the present invention in an automobile;

FIGS. 3A and 3B are perspective views showing a wireless charger for use in automobile according to a third embodiment of the present invention; and

FIG. 3C is a perspective view illustrating use of the wireless charger according to the third embodiment of the present invention in an automobile.

### DETAILED DESCRIPTION OF THE PREFERRED EMBODIMENTS

### First Embodiment

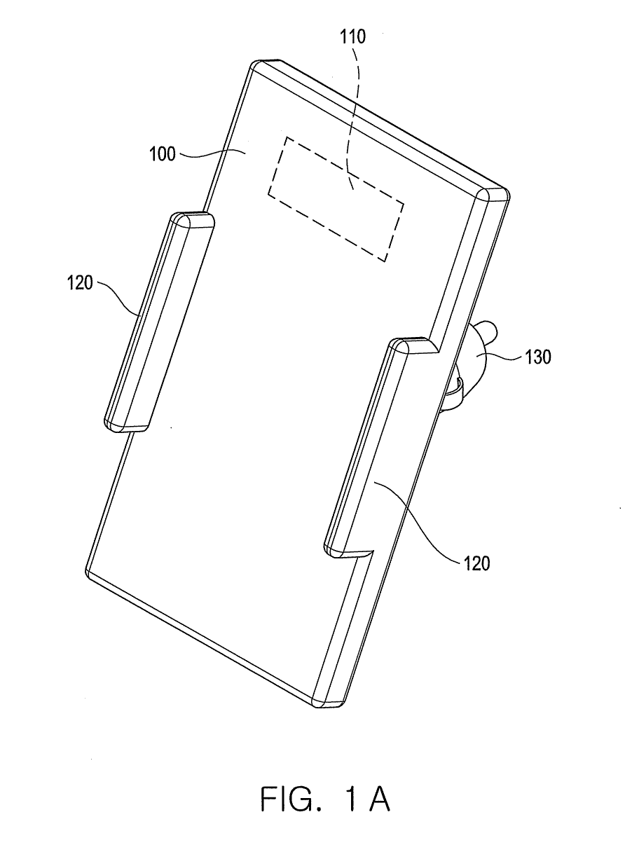

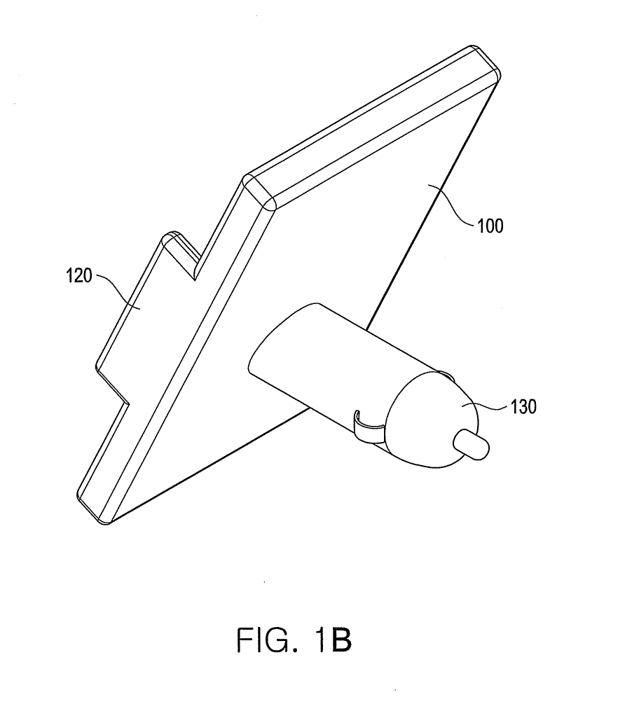

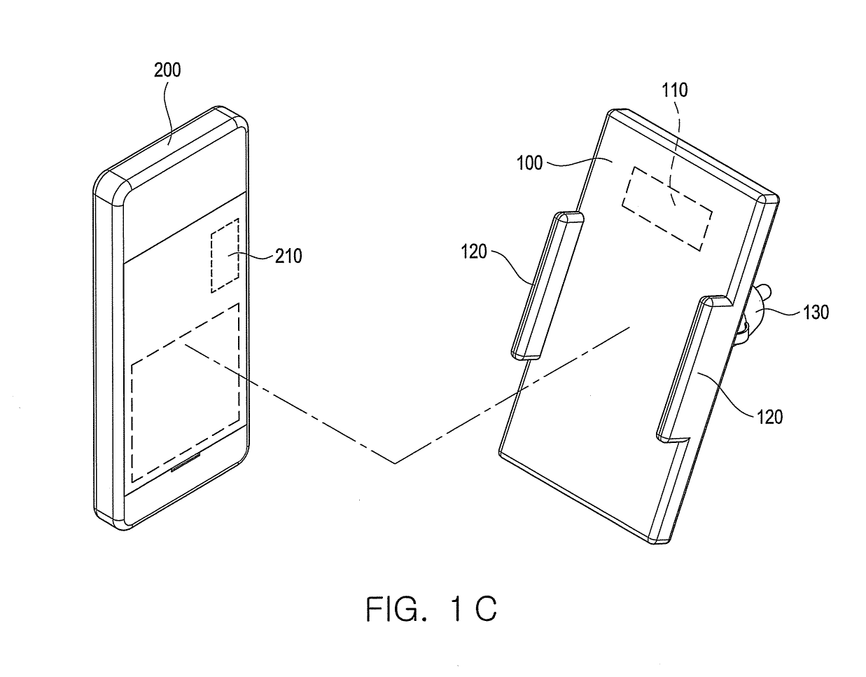

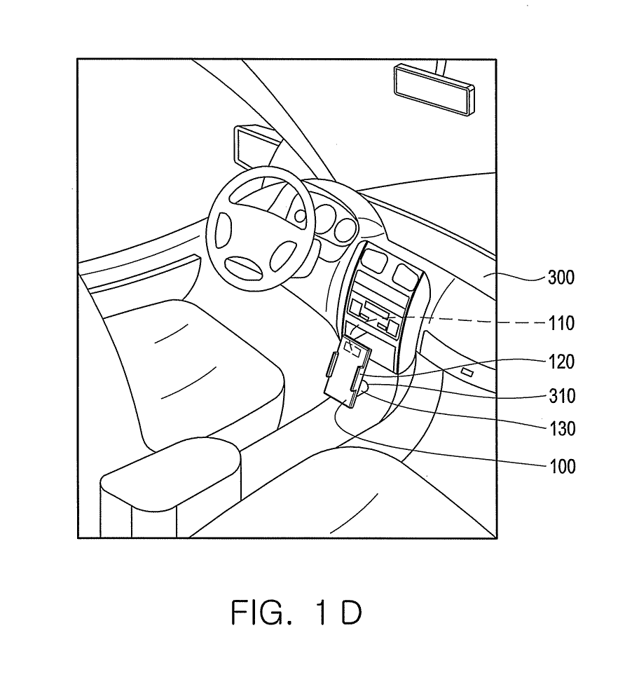

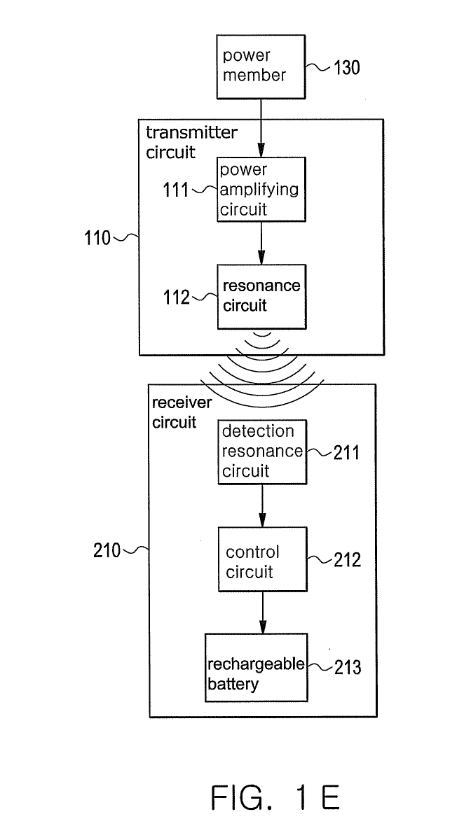

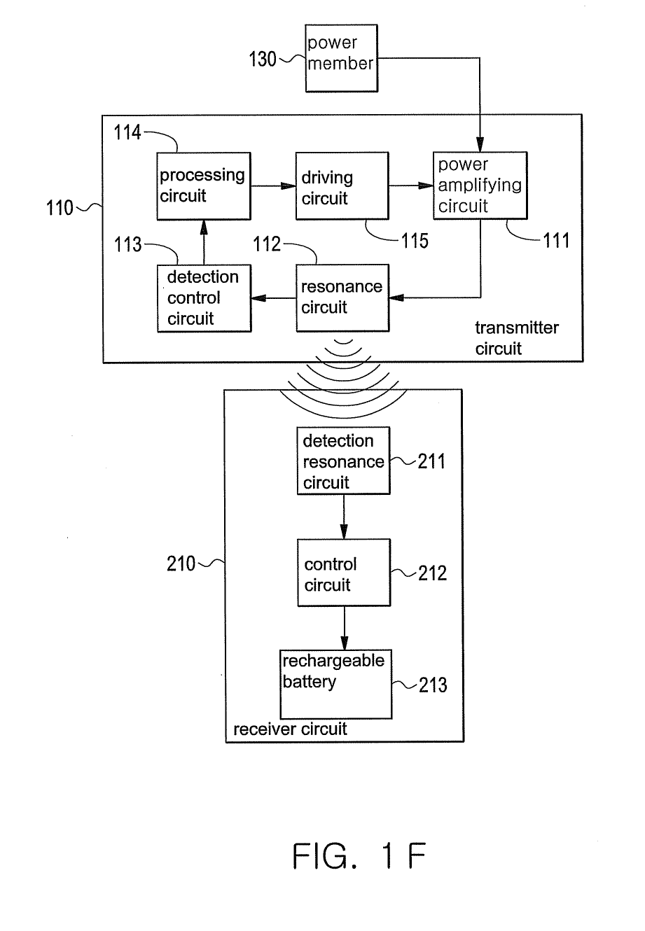

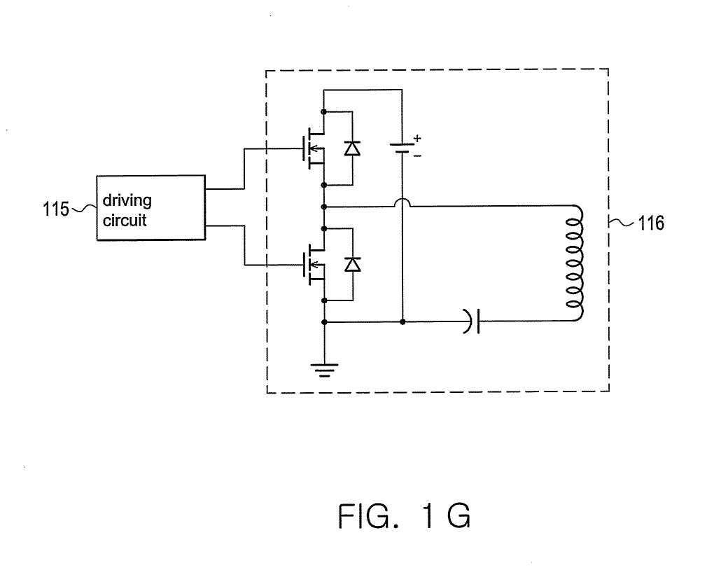

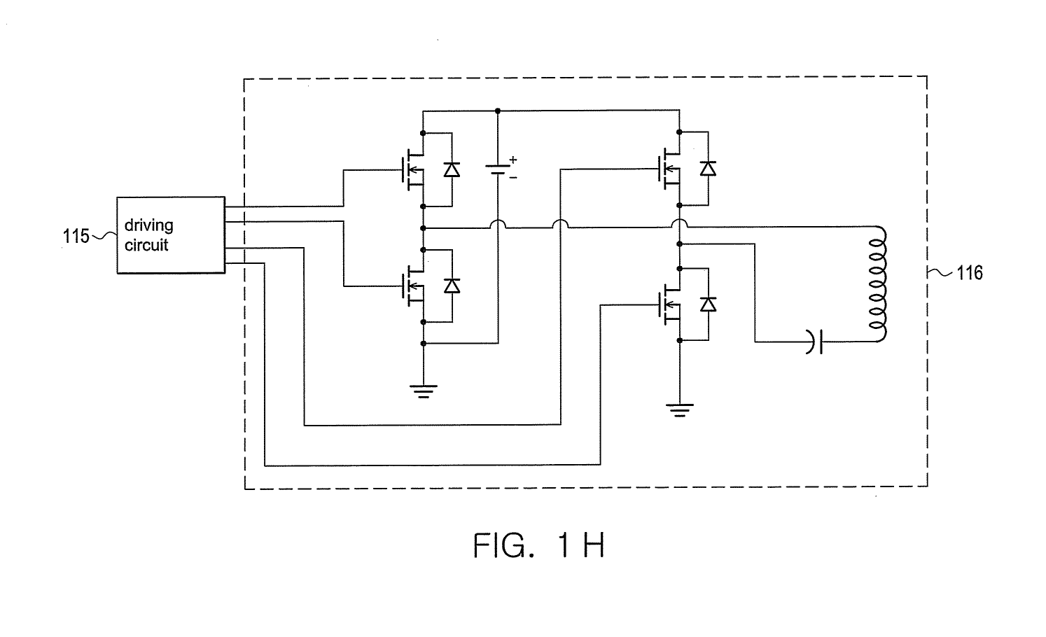

With reference to the drawings and in particular to FIGS. 1A-1H, which are respectively perspective views of a wireless charger for use in automobile according to an embodiment of the present invention, perspective views illustrating use of the wireless charger according to the present invention, and circuit diagrams of the wireless charger according to the present invention, the wireless charger according to the present invention comprises a main body 100 and a power member 130, which is provided for making the wireless charger usable in an automobile 300 that is equipped with a cigarette lighter 310a and allows a user to couple an electronic device 200 that comprises a receiver circuit 210 to the main body 100 for performance of a charging operation through wireless transmission.

The main body 100 comprises a transmitter circuit 110 and at least one clip section 120, whereby the electronic device 200 is positionable on the main body 100 and retained in position on the main body 100 through engagement with the clip section 120. The clip section 120 is made of an elastic material and comprises two portions respectively arranged on two opposite sides of the main body 100, whereby the clip section 120 is resiliently engageable with and thus fixes the electronic device 200 in position to securely retain the electronic device 200 on the main body 100.

The power member 130 has an end that is connected to the main body 100. The power member 130 has an opposite end that is electrically connectable with the cigarette lighter 310 of the automobile 300. The power member 130 transmits electrical power received from the cigarette lighter 310 to the transmitter circuit 110, whereby the transmitter circuit 110 converts the electrical power into an AC (alternate current) signal. The AC signal is then transmitted by the transmitter circuit 110 to the receiver circuit 210 through wireless transmission.

The transmitter circuit 110 comprises a power amplifying circuit 111 connected to the power member 130 and a resonance circuit 112 connected to the power amplifying circuit 111, whereby the power amplifying circuit 111 converts the electrical power supplied from the power member into the AC signal. The AC signal is subjected to amplification by the power amplifying circuit 111 and the amplified AC signal is processed by the resonance circuit 112 to retrieve resonance energy. The AC signal is then transmitted by the resonance circuit 112 to the receiver circuit 210 (see FIG. 1E).

Further, the transmitter circuit may further comprise a detection control circuit 113 connected to the resonance circuit 112, a processing circuit 114 connected to the detection control circuit 113, and a driving circuit 115 connected to the processing circuit 114 and the power amplifying circuit 111, whereby the detection control circuit 113 detects the magnitude of the AC signal transmitted by the resonance circuit 112 and the processing circuit 114, which is pre-provided with a predetermined signal, compares the predetermined signal with the AC signal to generate a frequency regulation signal based on which the driving circuit 115 regulates the signal frequency and thus the power of the power amplifying circuit 111 is regulated for feeding back and controlling the AC signal transmitted by the resonance circuit 112 and providing the AC signal with stabilized power (see FIG. 1F).

Further, the power amplifying circuit 111 and the resonance circuit 112 are both power circuits. Alternatively, the power amplifying circuit 111 and the resonance circuit 112 can be combined as a power integration circuit 116, which comprises a circuit generally composed of at least two metal-oxide-semiconductor field effect transistors (MOSFETs), at least one inductor, at least one capacitor, or other electronic components/devices, whereby the power integration circuit 116 forms a half-bridge power circuit (see FIG. 1G) or a full-bridge power circuit (see FIG. 1H).

The electronic device 200 is for example an electronic device equipped with a receiver circuit 210 (such as portable electronic products, including a multimedia player and a mobile phone). The receiver circuit 210 comprises an detection resonance circuit 211, a control circuit 212 connected to the detection resonance circuit 211, and a rechargeable battery 213 connected to the control circuit 212, whereby the detection resonance circuit 211 detects and receives the AC signal transmitted from the transmitter circuit 110 and the control circuit 212 converts the AC signal received by the detection resonance circuit 211 into electrical power and performs voltage regulation of the electrical power so converted. The electrical power is then stored in the rechargeable battery 213, whereby the rechargeable battery 213 may subsequently supply the electrical power to the main body 100.

In the embodiment illustrated, the power member 130 is directly mounted on a surface of the main body 100, and the power member 130 is electrically connectable with the cigarette lighter 310 of the automobile 300. The electronic device 200 in the embodiment is a mobile phone. A user may carry out electrical charging to the electronic device 200 during the travel of the automobile 300 by having the electronic device 200 retained by the clip section 120 of the main body 100 thereby fixing the electronic device 200 to the main body 100, so that the electrical power supplied from the cigarette lighter 310 is transmitted by the power member 130 to the transmitter circuit 110 and the transmitter circuit 110 converts the electrical power into an AC signal that is then transmitted by the transmitter circuit 110, through wireless transmission, to the receiver circuit 210 to electrically charge the rechargeable battery 213 of the receiver circuit 210. Thus, electrically charging the electronic device 200 during the travel of the automobile is realized. The problem of limited range of use caused by being only useful in an area where a power socket is available and requiring wired connection with the charger can thus be overcome, and ease of use is realized.

### Second Embodiment

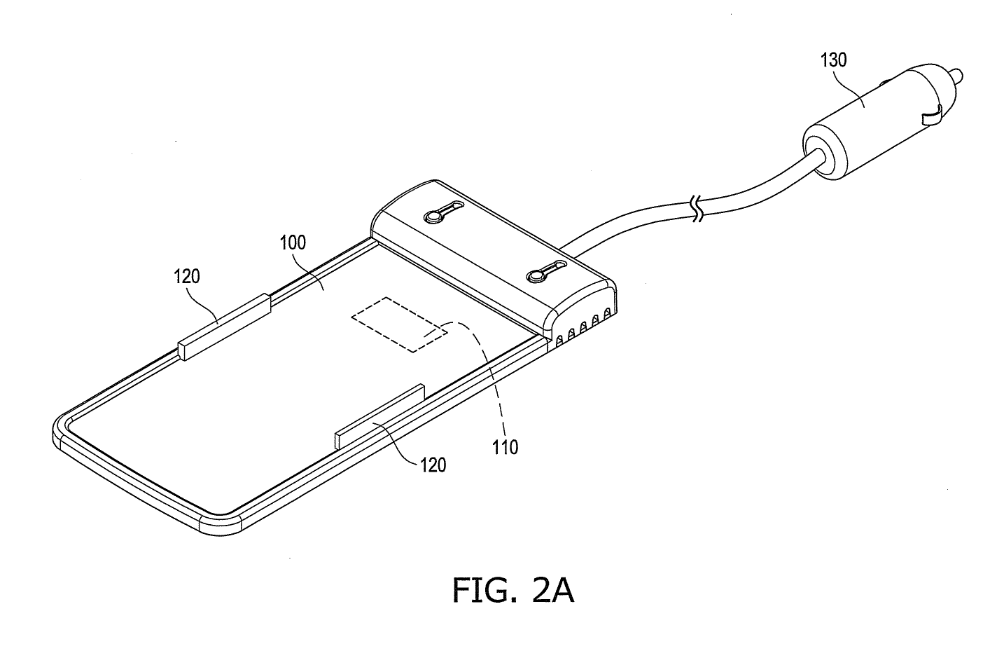

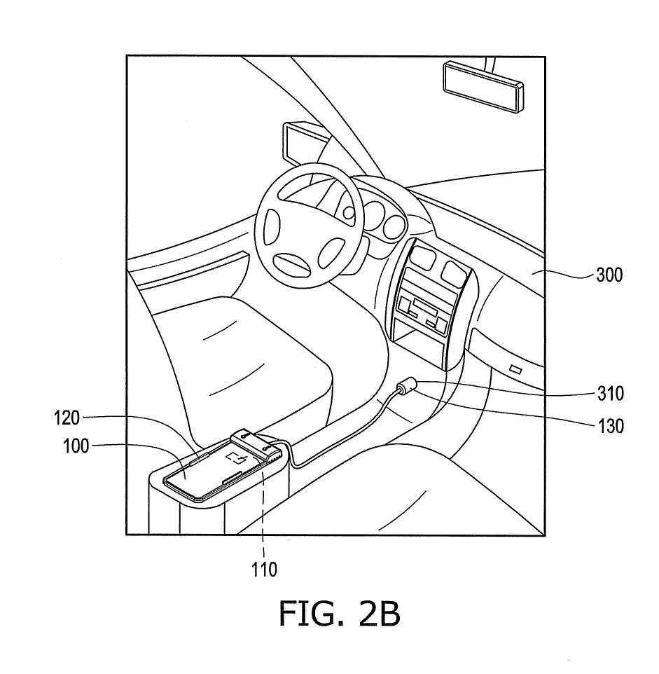

Referring to FIGS. 2A and 2B, which are respectively a perspective view showing a wireless charger for use in automobile according to a second embodiment of the present invention and a perspective view illustrating use of the wireless charger according to the second embodiment of the present invention in an automobile, the second embodiment is substantially identical to the first embodiment with a major difference therebetween being that the main body 100 and the power member 130 are connected to each other in a wired manner. In other words, the power member 130 can be a wired electrical connector that is easily available in the market, whereby when the power member 130 is electrically connected to the cigarette lighter 310 of the automobile 300, the main body 100 is positionable on any desired location within the automobile 300 (such as being positioned in a storage compartment beside the driver's seat and on a back seat). The electronic device 200 can be for example a mobile phone. During the travel of the automobile 300, a user may position the electronic device 200 on the main body 100 and the power member 130 transmits the electrical power supplied from the cigarette lighter 310 to the transmitter circuit 110 to allow the transmitter circuit 110 to convert the electrical power into an AC signal that is transmitted by the transmitter circuit 110 through wireless transmission to the receiver circuit 210 of the electronic device 200 and thus electrically charge the rechargeable battery 213 of the receiver circuit 210 of the electronic device 200. Ease of use can thus be realized.

### Third Embodiment

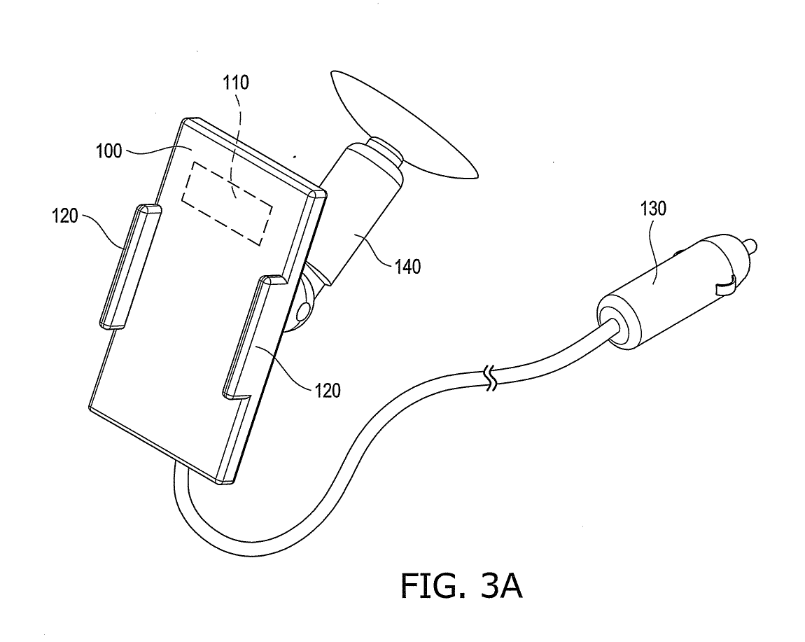

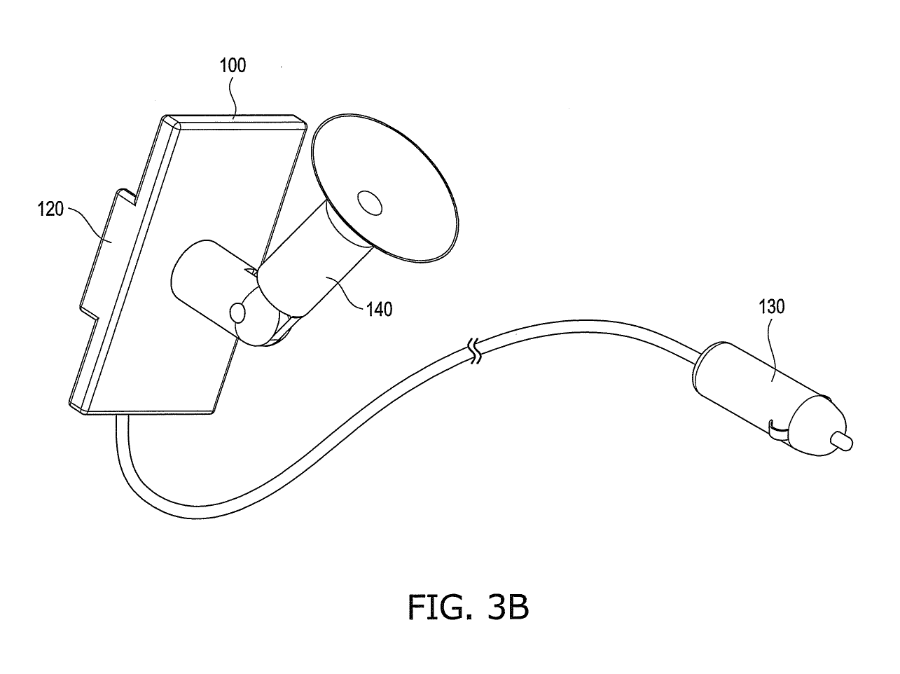

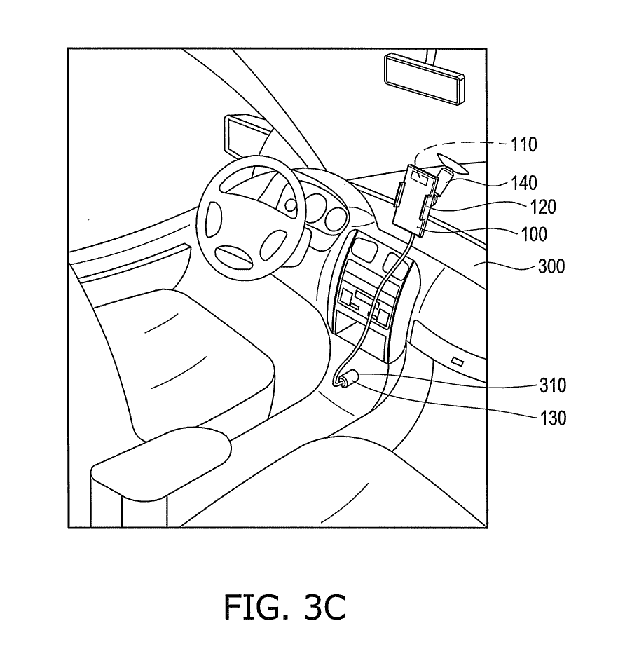

Referring to FIGS. 3A-3C, which are respectively perspective views showing a wireless charger for use in automobile according to a third embodiment of the present invention and a perspective view illustrating use of the wireless charger according to the third embodiment of the present invention in an automobile, the third embodiment is substantially identical to the first embodiment with a major difference therebetween being that at least one mounting member 140 (such as a clamp, a tying wire, a magnet, and a suction cup) is additionally included. The mounting member 140 is mounted on a surface of the main body 100 to allow the main body 100 to be fixed to the automobile 300 through the mounting member 140.

In the embodiment illustrated, the mounting member 140 comprises a suction cup, whereby the main body 100 can be attached to a windshield of the automobile 300 through suction engagement of the mounting member 140. The power member 130 comprises a wired connector that is available in the market, whereby when the power member 130 is electrically connected to the cigarette lighter 310 of the automobile 300, the power member 130 transmits the electrical power supplied from the cigarette lighter 310 to the transmitter circuit 110 to allow the transmitter circuit 110 to convert the electrical power into an AC signal, which is then transmitted by the transmitter circuit 110 through wireless transmission to the receiver circuit 210 of the electronic device 200, and thus electrical charging can be carried out to the rechargeable battery 213 of the receiver circuit 210.

In summary, the present invention provides a wireless charger for use in automobile, wherein a transmitter circuit and at least one clip section 120 is provided in a main body 100, whereby to electrically charge an electronic device 200, the electronic device 200 is retained in position on the main body 100 by the clip section 120 and a power member 130 is electrically connected to a cigarette lighter 310 of an automobile 300 to allow the power member 130 to transmit the electrical power supplied from the cigarette lighter 310 to the transmitter circuit 110. The electrical power is converted by the transmitter circuit 110 into an AC signal and the transmitter circuit 110 transmits, in a wireless manner, the AC signal to the receiver circuit 210 of the electronic device 200 to electrically charge the rechargeable battery 213 of the receiver circuit 210. As such, the problem of limited range of use caused by being only useful in an area where a power socket is available and requiring wired connection with the charger can thus be overcome, and ease of use is realized.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A wireless charger adapted to be used with an automobile comprising a cigarette lighter and coupleable with an electronic device comprising a receiver circuit, the wireless charger comprising:
a main body, which comprises a transmitter circuit and at least one clip section, the electronic device being positionable on the main body and engageable with the clip section to couple the electronic device with the main body; and
a power member, which has an end connected to the main body and an opposite end that is electrically connectable with the cigarette lighter of the automobile, whereby the power member transmits electrical power supplied from the cigarette lighter to the transmitter circuit to allow the transmitter circuit to convert the electrical power into an alternate-current signal, which is transmitted by the transmitter circuit to the receiver circuit in a wireless manner.

2. The wireless charger as claimed in claim 1 further comprising at least mounting member, which is mounted to a surface of the main body, whereby the mounting member attaches the main body to the automobile.

3. The wireless charger as claimed in claim 2, wherein the mounting member comprises one of a clamp, a tying wire, a magnet, and a suction cup.

4. The wireless charger as claimed in claim 1, wherein the transmitter circuit comprises a power amplifying circuit and a resonance circuit, the power amplifying circuit being connected to the power member, the power amplifying circuit converting the electrical power transmitted from the power member into an alternate-current signal and amplifying the alternate-current signal, the resonance circuit being connected to the power amplifying circuit, the resonance circuit transmitting the alternate-current signal that is amplified by the power amplifying circuit to the receiver circuit.

5. The wireless charger as claimed in claim 4, wherein the transmitter circuit further comprises a detection control circuit, a processing circuit, and a driving circuit, the detection control circuit being connected to the resonance circuit, the detection control circuit detecting magnitude of the alternate-current signal transmitted by the resonance circuit, the processing circuit being connected to the detection control circuit, the processing circuit being provided with a predetermined signal, the processing circuit comparing the predetermined signal with the alternate-current signal to generate a frequency regulation signal, the driving circuit being connected to the processing circuit and the power amplifying circuit, the driving circuit regulating signal frequency based on the frequency regulation signal and the driving circuit regulating power of the power amplifying circuit for feeding back and controlling the alternate-current signal transmitted by the resonance circuit to provide stabilized power of the alternate-current signal.

6. The wireless charger as claimed in claim 4, wherein the power amplifying circuit and the resonance circuit are combined as a power integration circuit.

7. The wireless charger as claimed in claim 6, wherein the power integration circuit comprises a circuit composed of at least two MOSFETs.

8. The wireless charger as claimed in claim 7, wherein the power integration circuit comprises one of a half-bridge power circuit and a full-bridge power circuit.

9. The wireless charger as claimed in claim 1, wherein the receiver circuit comprises a detection resonance circuit, a control circuit, and a rechargeable battery, the detection resonance circuit receiving the alternate-current signal transmitted by the transmitter circuit, the control circuit being connected to the detection resonance circuit, the control circuit converting the alternate-current signal received by the detection resonance circuit into electrical power and performing voltage regulation of the electrical power, the rechargeable battery being connected to the control circuit, the rechargeable battery storing the electrical power converted by the control circuit.
